(19) United States
(12) Patent Application Publication
(10) Pub. No.: US 2023/0232379 A1
(43) Pub. Date: Jul. 20, 2023

(54) BANDWIDTH PART SWITCHING METHOD, MOBILE COMMUNICATION SYSTEM, AND UE

(71) Applicant: JRD COMMUNICATION (SHENZHEN) LTD., Shenzhen, Guangdong (CN)

(72) Inventors: Tian Li, Shenzhen, Guangdong (CN); Jia Sheng, Shenzhen, Guangdong (CN)

(73) Assignee: JRD COMMUNICATION (SHENZHEN) LTD., Shenzhen, Guangdong (CN)

(21) Appl. No.: 17/998,806

(22) PCT Filed: May 12, 2021
(86) PCT No.: PCT/CN2021/093242

§ 371 Date: Nov. 14, 2022

(30) Foreign Application Priority Data
May 15, 2020 (CN) 202010414429.0

(51) Int. Cl. H04W 72/0446; H04W 72/232

(52) U.S. Cl. CPC H04W 72/0446; H04W 72/232

(57) ABSTRACT

A UE uses a first bandwidth part to simultaneously receive switching requests from a plurality of transmission/reception points in a first time slot, calculates a scheduling time offset value on the basis of a plurality of scheduling time offsets decoded from the switching requests, and does not perform wireless signal transmission in a duration of time after the end of the time of the first three symbols in the first time slot. The duration of time is determined by the scheduling time offset value.

### CROSS-REFERENCE TO RELATED APPLICATIONS

This application claims priority to Chinese Patent Application No. 202010414429.0, filed with the Chinese Patent Office on May 15, 2020 and entitled “BANDWIDTH PART SWITCHING METHOD”, which is incorporated herein by reference in its entirety.

### TECHNICAL FIELD

The present disclosure relates to the field of 5G new radio technologies, and particularly to a bandwidth part (BWP) switching method in a multi-transmission/reception point (TRP) environment.

### BACKGROUND

In the 3GPP international standard meeting RAN1#95, a multi-transmission/reception point TRP/panel transmission protocol was formulated, including a scheduling method for uplink and downlink transmission and a bandwidth part switching method.

As illustrated in FIG. 1, two transmission/reception points TRP1 110 and TRP2 120 respectively transmit a first switching request 102 and a second switching request 104 to a user equipment (UE) 130.

In the 3GPP Release 15, data scheduling timing is defined to include several scheduling time offsets K₀ to K₂ or is called transmission time restriction. The number of time slots is represented by a positive integer, and the time offset between each uplink and downlink communication is respectively defined.

However, in the environment of multiple transmission/reception points TRPs, when each transmission/reception point TRP requires independent resource allocation or other control information, the existing scheduling mechanism may have room for improvement.

In Release 16, non-coherent joint transmission (NC-JT) adopts multi-transmission/reception point TRP/panel transmission technology, and the scheduling timing can be determined according to single physical downlink control channel PDCCH or multiple physical downlink control channels PDCCHs.

A bandwidth part used by a user equipment UE to connect to a mobile network is generally determined by a higher layer parameter, such as a downlink bandwidth part (BWP-Downlink), an initial downlink bandwidth part (initialDownlinkBWP), an uplink bandwidth part (BWP-Uplink), or an initial uplink bandwidth part (initialUplinkBWP)), etc. This can be calculated with a series of other related parameters, and at most four groups can be used.

In the known standard specification, there is a set of higher layer parameters called CORESETPoolIndex, which can be obtained from a higher layer parameter ControlResourceSet and used to confirm a transmission/reception point TRP. When a user equipment UE receives a set of higher layer parameters ControlResourceSet in use by a mobile network, including two different CORESETPoolIndex, the user equipment UE expects to communicate with at most two different transmission/reception points TRPs.

Traditionally, the first method to trigger a bandwidth part switching is through a timer defined by a higher layer. Another method is through downlink control information (DCI). For example, a bandwidth part indicator field is defined in an uplink scheduling downlink control information (UL Scheduling DCI) (e.g., DCI format 0_1), and a value of the bandwidth part indicator field indicates an uplink bandwidth part that should be used. When the user equipment UE receives an uplink scheduling downlink control information DCI, if the uplink bandwidth part that the user equipment UE is using is not the uplink bandwidth part that should be used, the user equipment UE must switch to the uplink bandwidth part designated by the uplink scheduling downlink control information DCI. In the environment of multiple transmission/reception points TRPs, the switching of the bandwidth part is performed cooperatively by all transmission/reception points TRPs.

However, when multiple downlink control information DCIs are scheduled and determined by multiple transmission/reception points TRPs respectively, some issues may arise. For example, if multiple transmission/reception points TRPs coincidentally trigger the bandwidth part switching procedure in the same time slot, the minimum transmission time limit lacks an effective mechanism for proper scheduling. If an offset value is not clearly defined, the user equipment UE cannot determine when to start a new bandwidth part transmission or reception. Therefore, the present disclosure proposes a bandwidth part switching method in a multi-transmission/reception point TRP/panel environment.

### SUMMARY

In order to solve the above technical problems, the present disclosure provides a bandwidth part switching method for a user equipment UE in a mobile communication system to simultaneously connect a plurality of transmission/reception points TRPs for mobile network communication. First, the user equipment UE performs a receiving step to receive corresponding switching requests from the plurality of transmission/reception points TRPs, and each switching request includes a scheduling time offset. For example, the user equipment UE receives a first switching request RQ1 from a first transmission/reception point TRP1, the first switching request includes a first scheduling time offset, and the user equipment UE receives a second switching request from a second transmission/reception point TRP2, the second switching request includes a second scheduling time offset. Then, the user equipment UE calculates a scheduling time offset value T_{OFFSET} according to corresponding scheduling time offsets decoded from the switching requests. The user equipment UE does not transmit and receive wireless signals within a duration of time after receiving the first switching request RQ1 and the second switching request RQ2.

The duration of time is determined by the scheduling time offset value T_{OFFSET}, and the user equipment UE receives the first switching request RQ1 and the second switching request RQ2 at approximately the same time.

In one embodiment, the first switching request RQ1 and the second switching request RQ2 are uplink scheduling downlink control information (UL Scheduling DCI) carried by a physical downlink control channel (PDCCH). The duration of time is counted from an end of a third symbol time in the first time slot and extends to a beginning of a time slot corresponding to the scheduling time offset value T_{OFFSET}. The scheduling time offsets are uplink transmission offsets (K₂) as defined by a 5G new radio technology standard specification release 16, and the receiving step is performed on a first bandwidth part.

The user equipment UE includes a minimum scheduling offset and calculates a minimum scheduling offset restriction K₂ₘᵢₙ from a minimum available scheduling offset indicator field in the uplink scheduling downlink control information DCI.

A step of calculating the scheduling time offset value T_{OFFSET} can include taking a minimum value as the scheduling time offset value T_{OFFSET} from the minimum scheduling offset restriction K₂ₘᵢₙ and at least the scheduling time offsets.

Calculating the scheduling time offset value T_{OFFSET} can also include calculating a maximum value of the scheduling time offsets and selecting a smaller one as the scheduling time offset value T_{OFFSET} from the minimum scheduling offset restriction K₂ₘᵢₙ and the maximum value.

Another calculating method of the scheduling time offset value T_{OFFSET} can also include calculating an average value of scheduling time offsets obtained by the user equipment UE from each connected transmission/reception point TRP and selecting a smaller one as the scheduling time offset value T_{OFFSET} from the minimum scheduling offset restriction K₂ₘᵢₙ and the average value.

A step of calculating the scheduling time offset value T_{OFFSET} can also include the user equipment UE reading a corresponding scheduling time offset as a selected value from a DCI carried by a transmission/reception point and selecting a smaller one as the scheduling time offset value T_{OFFSET} from the minimum scheduling offset restriction K₂ₘᵢₙ and the selected value; wherein the transmission/reception point is specified by a higher layer parameter CORESETPoolIndex. For example, when CORESETPoolIndex=0, it corresponds to a transmission/reception point whose ID is 0.

Another method of calculating the scheduling time offset value T_{OFFSET} can also include the user equipment UE selecting an earliest decoded scheduling time offset as a selected value from the switching requests received from all connected transmission/reception points TRPs and selecting a smaller one as the scheduling time offset value T_{OFFSET} from the minimum scheduling offset restriction K₂ₘᵢₙ and the selected value.

In another embodiment, the first switching request and the second switching request are downlink scheduling downlink control information (DL Scheduling DCI) carried by a physical downlink control channel PDCCH. The scheduling time offsets are downlink transmission offsets (K₀) as defined by a 5G new radio technology standard specification release 16, and the receiving step is performed at a first bandwidth part. After the number of time slots corresponding to the scheduling time offset value T_{OFFSET}, the user equipment UE uses a second bandwidth part different from the first bandwidth part to connect to each transmission/reception point TRP. The user equipment UE calculates a minimum scheduling offset restriction K₀ₘᵢₙ according to a higher layer parameter (physical downlink shared channel aggregation factor; pdsch-Aggregation Factor).

A step of calculating the scheduling time offset value T_{OFFSET} can include taking a maximum value from the scheduling time offsets and taking a minimum value as the scheduling time offset value T_{OFFSET} from the K₀ₘᵢₙ and the maximum value.

A step of calculating the scheduling time offset value T_{OFFSET} can also include the user equipment UE selecting one from all connected transmission/reception points TRPs to allow a corresponding scheduling time offset as a selected value and selecting a smaller one as the scheduling time offset value T_{OFFSET} from the K₀ₘᵢₙ and the selected value.

A step of calculating the scheduling time offset value T_{OFFSET} can also include the user equipment UE selecting an earliest decoded scheduling time offset as a selected value from the switching requests received from all connected transmission/reception points TRPs and selecting a smaller one as the scheduling time offset value T_{OFFSET} from the K₀ₘᵢₙ and the selected value.

Because the above-mentioned bandwidth part switching method is mainly implemented by the mobile communication system and the user equipment without changing the hardware structure, the claims of the present invention also claim to protect the mobile communication system and the user equipment that can be used to execute the above-mentioned bandwidth part switching method. Because the specific embodiments of the mobile communication system and the user equipment have been completely disclosed in the above-mentioned bandwidth part switching method, they will not be repeated. More specific embodiments will be described in detail later with the accompanying drawings.

### BRIEF DESCRIPTION OF THE DRAWINGS

In order to illustrate the embodiments or technical solutions in the prior art more clearly, the following briefly introduces the accompanying drawings that are required to be used in the description of the embodiments or the prior art. Obviously, the drawings in the following description are only some embodiments of the invention. For those of ordinary skill in the art, other drawings can also be obtained from these drawings without creative effort.

FIG. 1 is a multi-TRP environment architecture 100 of a known mobile communication system.

FIG. 2 is an embodiment 200 of uplink bandwidth part switching.

FIG. 3 is an embodiment 300 of downlink bandwidth part switching.

FIG. 4 is a flowchart 400 of a method for implementing bandwidth part switching in a mobile communication system of the present disclosure.

### DETAILED DESCRIPTION OF ILLUSTRATED EMBODIMENTS

The present disclosure is based on a multi-TRP environment architecture 100 of a mobile communication system in FIG. 1, but can be further extended to a method of performing a bandwidth part BWP switching method based on the multi-transmission/reception point TRP environment for a user equipment UE with N transmission/reception points TRPs simultaneously. Assuming that before switching the bandwidth part BWP, all transmission/reception points TRPs use a first bandwidth part BWP1 to communicate with the user equipment UE, then after the switching is completed, all the transmission/reception points TRPs use a second bandwidth part BWP2 to communicate with the user equipment UE. As for the usage scenarios, it is divided into uplink and downlink, and there are different embodiments respectively.

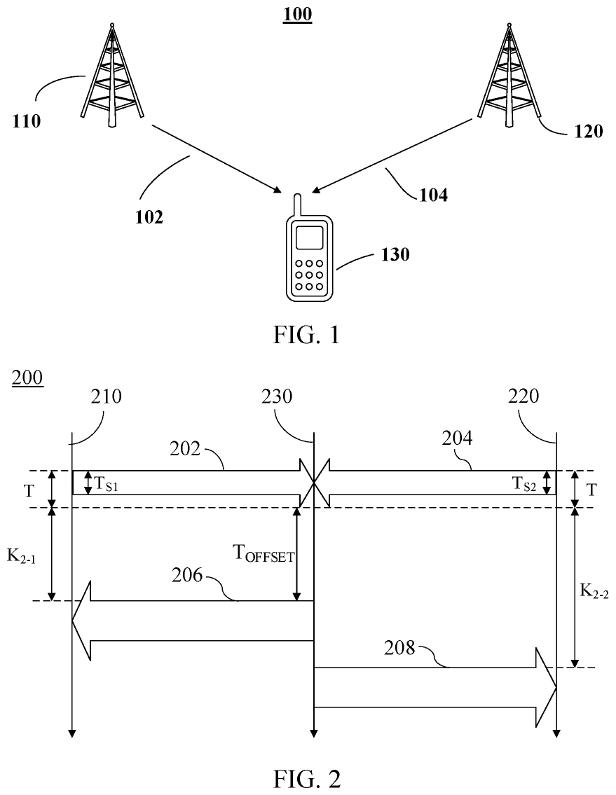

Referring to FIG. 2, FIG. 2 is an embodiment of uplink bandwidth part switching. For the convenience of description, the detailed process is described with two transmission/reception points TRPs. In an embodiment 200, two transmission/reception points TRP1 210, TRP2 220 and a user equipment (UE) 230 are included. The TRP1 210 and TRP2 220 coincidentally send a first switching request 202 and a second switching request 204 to the UE 230 in the same time slot T. The first switching request 202 is a first uplink scheduling downlink control information DCI1 carried by a first physical downlink control channel PDCCH1, and the second switching request 204 is a second uplink scheduling downlink control information DCI2 carried by a second physical downlink control channel PDCCH2. Each DCI includes a time domain resource assignment field, and the value solved therefrom is a scheduling time offset K₂ corresponding to the TRP1 210 and the TRP2 220, which is expressed as K₂₋₁ and K₂₋₂. If there are N transmission/reception points TRPs, the corresponding scheduling time offset is expressed as K_{2-N}. The UE 230 of the present disclosure uses a scheduling time offset value T_{OFFSET} obtained by performing operations on these scheduling time offsets K₂ and a minimum scheduling offset restriction K₂ₘᵢₙ, as the timing basis for transmission of the second bandwidth part BWP2.

As an embodiment, assuming that the user equipment UE has set a higher layer parameter, that is minimum scheduling offset, the minimum scheduling offset restriction K₂ₘᵢₙ is a minimum scheduling offset restriction defined by a minimum available scheduling offset indicator field in an uplink scheduling downlink control information (UL scheduling DCI). The so-called higher layer parameter generally refers to a parameter preset according to a higher layer system of a 5G communication network, which is known specification, and is only cited here as an example, without further description.

After the scheduling time offset value T_{OFFSET} is calculated, the user equipment UE maintains a state of neither transmitting nor receiving wireless signals within T_{OFFSET} time slots after the time slot T. The original step of triggering bandwidth part BWP switching is performed on a first bandwidth part BWP1, and after the bandwidth part switching is completed, the above-mentioned step of sending the physical uplink shared channel PUSCH is performed using the switched second bandwidth part BWP2.

In an embodiment, assuming that there are N transmission/reception points TRPs and one user equipment UE to form a multi-transmission/reception point TRP network environment, the calculation method of the scheduling time offset value T_{OFFSET} is shown in the formula (1), from the minimum scheduling offset restriction K₂ₘᵢₙ and at least these scheduling time offsets, a minimum value is taken as the scheduling time offset value T_{OFFSET}.

T_{OFFSET}=min(K₂ₘᵢₙ, K₂₋₁, K₂₋₂, . . . , K_{2-N}) (1)

In this embodiment, the time is based on a time slot as a basic unit. These scheduling time offset K₂ values are all integers, representing the number of time slots. Therefore, the user equipment UE actually maintains a state of not transmitting and not receiving between T_{OFFSET} time slots after one time slot T.

Because the essence of the first switching request 202 and the second switching request 204 is a kind of uplink scheduling downlink control information (UL scheduling DCI), the transmission time only occupies three symbol times (T_{S1} and T_{S2} shown in FIG. 2), which is less than one time slot T. Therefore, to be more precise, the time that the user equipment UE maintains the non-transmitting and non-receiving state starts from the time after T_{S1} (T_{S2}) until the end of the (T+T_{OFFSET})th time slot. Taking FIG. 2 as an example, the scheduling time offset value T_{OFFSET} may be exactly equal to the smallest of K₂, that is K₂₋₁.

In another embodiment, considering the differences in the performance of different user equipments UEs themselves, if the user equipment UE takes a long time to switch the bandwidth part and does not want to continuously receive other uplink scheduling and downlink control information DCI during the period, it can use larger scheduling time offset value T_{OFFSET}. The user equipment UE may first calculate a maximum value of these scheduling time offsets, and then select the smaller one as the scheduling time offset value T_{OFFSET} from the minimum scheduling offset restriction K₂ₘᵢₙ and the maximum value, as shown in the formula (2):

T_{OFFSET}=min{K₂ₘᵢₙ, max(K₂₋₁, K₂₋₂, . . . , K_{2-N})} (2)

In another embodiment, considering that in general, transmission reliability and performance are always difficult to achieve, a trade-off must be made, so taking a balance is also a method. As shown in formula (3), the user equipment UE first calculates an average value of the scheduling time offset K₂ obtained from each connected transmission/reception point TRP, and then selects the smaller one as the scheduling time offset value T_{OFFSET} from the minimum scheduling offset restriction K₂ₘᵢₙ and the average value.

T_{OFFSET}=min{K₂ₘᵢₙ,(K₂₋₁, K₂₋₂, . . . , K_{2-N})/N} (3)

In a further embodiment, to emphasize the simplification of design, the user equipment UE can directly make the scheduling time offset corresponding to a transmission/reception point TRP to a selected value and select the smaller one as the scheduling time offset value T_{OFFSET} from the minimum scheduling offset restriction K₂ₘᵢₙ and the selected value, as shown in formula (4):

T_{OFFSET}=min{K₂ₘᵢₙ, K₂} (4)

K₂ represents the selected value. The transmission/reception point is a TRP corresponding to a pre-configured or preset CORESETPoolIndex value (for example, CORESETPoolIndex=0). K₂ is a slot offset value decoded from a time domain resource assignment field in the uplink scheduling downlink control information DCI provided by the physical downlink control channel PDCCH of the TRP.

In another embodiment with simplified design, if the user equipment UE receives multiple uplink scheduling downlink control information DCIs at the same time, but only one downlink control information DCI can be selected for bandwidth part switching, other downlink control information DCIs are discarded. In addition to random selection, the method for selecting the downlink control information DCI can also directly adopt the first successful decoding. As shown in formula (5), the user equipment UE selects the earliest decoded scheduling time offset as a selected value K₂ from the switching requests received from all connected transmission/reception points TRPs, and then selects the smaller one as the scheduling time offset value T_{OFFSET} from the minimum scheduling shift limit K₂ₘᵢₙ and the selected value K₂.

T_{OFFSET}=min{K₂ₘᵢₙ, K₂} (5)

Referring to FIG. 3, FIG. 3 is an embodiment of downlink bandwidth part switching. The detailed process is also described with two transmission/reception points TRPs. In this embodiment 300, two transmission/reception points TRP1 310, TRP2 320 and one UE 330 are included. The TRP1 310 and TRP2 320 send a first switching request 302 and a second switching request 304 to the UE 330 in the same time slot T. The first switching request 302 is a first downlink scheduling downlink control information DCI1 carried by a first physical downlink control channel PDCCH1, and the second switching request 304 is a second downlink scheduling downlink control information DCI2 carried by a second physical downlink control channel PDCCH2. Each downlink scheduling DCI includes a time domain resource assignment field, and the value solved therefrom is a scheduling time offset K₀ corresponding to the TRP1 310 and the TRP2 320, which is expressed as K₀₋₁ and K₀₋₂. If there are N transmission/reception points TRPs, the corresponding scheduling time offset is expressed as K_{0-N}. The UE 330 of the present disclosure uses a scheduling time offset value T_{OFFSET} obtained by performing operations on these scheduling time offsets K₀ and a minimum scheduling offset restriction K₀ₘᵢₙ, as the timing basis for transmission of new bandwidth part.

After the scheduling time offset value T_{OFFSET} is calculated, the user equipment UE maintains a state of neither transmitting nor receiving wireless signals during the period after the time slot T. The original step of triggering bandwidth part BWP switching is performed on a first bandwidth part BWP1, and after the bandwidth part switching is completed, the above-mentioned receiving step is performed using the switched second bandwidth part BWP2.

In one embodiment, considering the performance difference of the user equipment UE, it may not be possible to detect other downlink scheduling downlink control information DCI (such as downlink control information DCI format 1_1) within the minimum delay time required for processing the bandwidth part switching process, and therefore tend to use larger scheduling time offsets. First, the user equipment UE calculates a minimum scheduling offset restriction K₀ₘᵢₙ according to a higher layer parameter (physical downlink shared channel aggregation factor; pdsch-Aggregation Factor). Then, according to the formula (6), a maximum value is taken from these scheduling time offsets, and a minimum value is taken from the K₀ₘᵢₙ and the maximum value as the scheduling time offset value T_{OFFSET}.

T_{OFFSET}=min{K₀ₘᵢₙ,max(K₀₋₁, K₀₋₂, . . . , K_{0-N})} (6)

In another embodiment, considering the requirement of simplifying the design, the user equipment UE can directly make the scheduling time offset corresponding to a transmission/reception point TRP as a selected value, and then select the smaller one as the scheduling time offset value T_{OFFSET} from the K₀ₘᵢₙ and the selected value.

T_{OFFSET}=min{K₀ₘᵢₙ, K₀} (7)

K₀ represents the selected value. The transmission/reception point TRP is a TRP corresponding to a preconfigured or preset CORESETPoolIndex value (for example, CORESETPoolIndex=0). K₂ is a slot offset value decoded from a time domain resource assignment field) in the downlink scheduling downlink control information DCI provided by the physical downlink control channel PDCCH of the TRP.

In another embodiment with simplified design, if the user equipment UE receives multiple downlink scheduling downlink control information DCIs at the same time, but only one downlink scheduling downlink control information DCI can be selected for bandwidth part switching, other downlink scheduling downlink control information DCIs are discarded. In addition to random selection, the method for selecting the downlink scheduling downlink control information DCI can also directly adopt the first successful decoding. As shown in formula (8), the user equipment UE selects the earliest decoded scheduling time offset as a selected value K₀ from the switching requests received from all connected transmission/reception points TRPs, and then selects the smaller one as the scheduling time offset value T_{OFFSET} from the minimum scheduling shift limit K₀ₘᵢₙ and the selected value.

T_{OFFSET}=min{K₀ₘᵢₙ, K₀} (8)

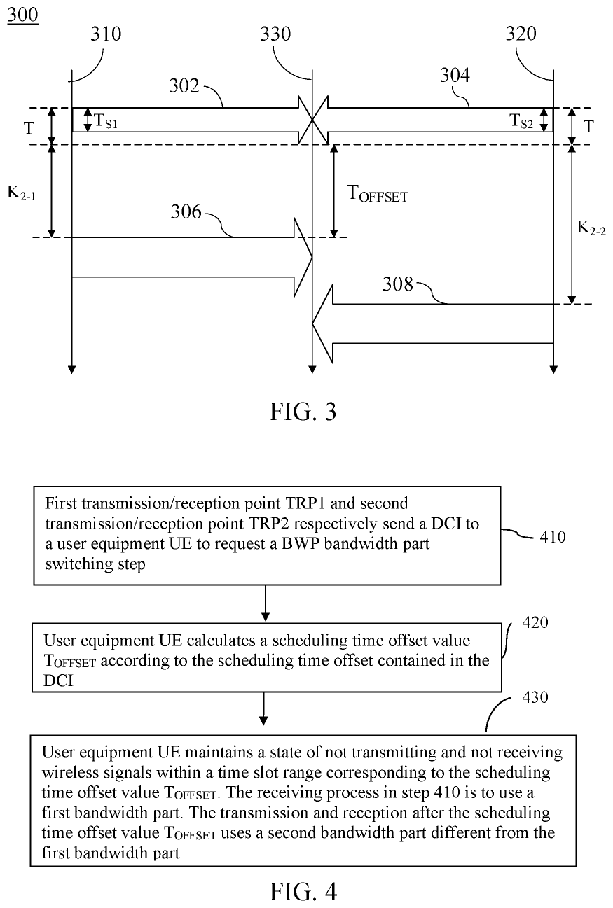

Summarizing the above embodiments, it can be summarized into a flowchart of a method for implementing bandwidth part switching in a mobile communication system shown in FIG. 4. First, in step 410, the first transmission/reception point TRP and the second transmission/reception point TRP respectively send a first bandwidth part switching request and a second bandwidth part switching request to a user equipment UE. In step 420, the user equipment UE calculates a scheduling time offset value T_{OFFSET} according to a scheduling time offset K included in the first bandwidth part switching request and the second bandwidth part switching request. In step 430, the user equipment UE maintains a state of not transmitting and not receiving wireless signals within the time slot range corresponding to the scheduling time offset value T_{OFFSET}. The receiving process in step 410 is to use the first bandwidth part. Transmission and reception after the scheduled time offset value T_{OFFSET} uses a second bandwidth part different from the first bandwidth part.

The present disclosure is a design improvement based on 3GPP NR. Although the present invention has been disclosed above with preferred embodiments, the above preferred embodiments are not intended to limit the present invention. Those skilled in the art can make various changes and modifications without departing from the spirit and scope of the present invention. Therefore, the protection scope of the present invention is subject to the scope defined by the claims.

1. A bandwidth part switching method for a user equipment in a mobile communication system to simultaneously connect a plurality of transmission/reception points (TRPs) for mobile network communication, comprising:
the user equipment performing a receiving step to receive corresponding switching requests from the plurality of TRPs, each switching request comprising a scheduling time offset, and the receiving step further comprising at least:
the user equipment receiving a first switching request from a first TRP, the first switching request comprising a first scheduling time offset; and
the user equipment receiving a second switching request from a second TRP, the second switching request comprising a second scheduling time offset;
the user equipment calculating a scheduling time offset value T_{OFFSET} according to corresponding scheduling time offsets decoded from the switching requests;
wherein the user equipment does not transmit and receive wireless signals within a duration of time after receiving the first switching request and the second switching request; wherein:
the first switching request and the second switching request are used to request a bandwidth part in use for switching;
the duration of time is determined by the scheduling time offset value T_{OFFSET}; and
the user equipment simultaneously receives the first switching request and the second switching request in a first time slot using a first bandwidth part.

2. The bandwidth part switching method as claimed in claim 1, wherein:
the first switching request and the second switching request are uplink scheduling downlink control information (DCI) carried by a physical downlink control channel and occupying first three symbol times in the first time slot;
the duration of time is counted from an end of a third symbol time in the first time slot and extends to a beginning of a time slot corresponding to the scheduling time offset value T_{OFFSET};
the scheduling time offsets are uplink transmission offsets K₂ as defined by a 5G new radio technology standard specification release 16.

3. The bandwidth part switching method as claimed in claim 1, further comprising:
after a time corresponding to the scheduling time offset value T_{OFFSET}, the user equipment switches to a second bandwidth part different from the first bandwidth part to communicate with the first TRP and the second TRP.

4. The bandwidth part switching method as claimed in claim 2, further comprising:
the user equipment comprising a minimum scheduling offset and calculating a minimum scheduling offset restriction K₂ₘᵢₙ from a minimum available scheduling offset indicator field in the uplink scheduling DCI.

5. The bandwidth part switching method as claimed in claim 4, wherein a step of calculating the scheduling time offset value T_{OFFSET} comprises: taking a minimum value as the scheduling time offset value T_{OFFSET} from the minimum scheduling offset restriction K₂ₘᵢₙ and at least the scheduling time offsets.

6. The bandwidth part switching method as claimed in claim 4, wherein a step of calculating the scheduling time offset value T_{OFFSET} comprises: calculating a maximum value of the scheduling time offsets; and
selecting a smaller one as the scheduling time offset value T_{OFFSET} from the minimum scheduling offset restriction and the maximum value.

7. The bandwidth part switching method as claimed in claim 4, wherein a step of calculating the scheduling time offset value T_{OFFSET} comprises: calculating an average value of scheduling time offsets obtained by the user equipment from each connected TRP; and
selecting a smaller one as the scheduling time offset value T_{OFFSET} from the minimum scheduling offset restriction and the average value.

8. The bandwidth part switching method as claimed in claim 4, wherein a step of calculating the scheduling time offset value T_{OFFSET} comprises:
the user equipment reading a corresponding scheduling time offset as a selected value from a DCI carried by a TRP; and
selecting a smaller one as the scheduling time offset value T_{OFFSET} from the minimum scheduling offset restriction K₂ₘᵢₙ and the selected value; wherein the TRP is specified by a higher layer parameter CORESETPoolIndex.

9. The bandwidth part switching method as claimed in claim 4, wherein a step of calculating the scheduling time offset value T_{OFFSET} comprises:
the user equipment selecting an earliest decoded scheduling time offset as a selected value from the switching requests received from all connected TRPs;
selecting a smaller one as the scheduling time offset value T_{OFFSET} from the minimum scheduling offset restriction and the selected value.

10. The bandwidth part switching method as claimed in claim 1, wherein:
the first switching request and the second switching request are downlink scheduling DCI carried by a physical downlink control channel and occupying first three symbol times in the first time slot;
the duration of time is counted from an end of a third symbol time in the first time slot and extends to a beginning of a time slot corresponding to the scheduling time offset value T_{OFFSET};
the scheduling time offsets are downlink transmission offsets K₀ as defined by a 5G new radio technology standard specification release 16.

11. The bandwidth part switching method as claimed in claim 10, further comprising:
the user equipment calculating a minimum scheduling offset restriction K₀ₘᵢₙ according to a higher layer parameter.

12. The bandwidth part switching method as claimed in claim 11, wherein a step of calculating the scheduling time offset value T_{OFFSET} comprises:
taking a maximum value from the scheduling time offsets; and
taking a minimum value as the scheduling time offset value T_{OFFSET} from the minimum scheduling offset restriction K₀ₘᵢₙ and the maximum value.

13. The bandwidth part switching method as claimed in claim 11, wherein a step of calculating the scheduling time offset value T_{OFFSET} comprises:
the user equipment reading a corresponding scheduling time offset as a selected value from a DCI carried by a TRP; and
selecting a smaller one as the scheduling time offset value T_{OFFSET} from the minimum scheduling offset restriction K₀ₘᵢₙ and the selected value, wherein a selected TRP is based on the TRP corresponding to the DCI in the switching request; wherein the TRP is specified by a higher layer parameter CORESETPoolIndex.

14. The bandwidth part switching method as claimed in claim 11, wherein a step of calculating the scheduling time offset value T_{OFFSET} comprises:
the user equipment selecting an earliest decoded scheduling time offset as a selected value from the switching requests received from all connected TRPs;
selecting a smaller one as the scheduling time offset value T_{OFFSET} from the minimum scheduling offset restriction K₀ₘᵢₙ and the selected value.

15. A mobile communication system, comprising a plurality of transmission/reception points (TRPs) connected to a user equipment simultaneously to allow the user equipment to perform mobile network communication, comprising:
the mobile communication system transmitting switching requests from the TRPs to allow the user equipment to receive a first switching request from a first TRP and receive a second switching request from a second TRP while using a first bandwidth part in a first time slot, wherein the first switching request comprises a first scheduling time offset, and the second switching request comprises a second scheduling time offset; wherein:
the user equipment calculates a scheduling time offset value T_{OFFSET} according to corresponding scheduling time offsets decoded from the switching requests; the user equipment does not transmit and receive wireless signals within a duration of time after receiving the first switching request and the second switching request;
the first switching request and the second switching request are used to request a bandwidth part in use for switching; and
the duration of time is determined by the scheduling time offset value T_{OFFSET}.

16. The mobile communication system as claimed in claim 15, wherein:
the first switching request and the second switching request are uplink scheduling downlink control information (DCI) carried by a physical downlink control channel and occupying first three symbol times in the first time slot;
the duration of time is counted from an end of a third symbol time in the first time slot and extends to a beginning of a time slot corresponding to the scheduling time offset value T_{OFFSET};
the scheduling time offsets are uplink transmission offsets K₂ as defined by a 5G new radio technology standard specification release 16.

17. The mobile communication system as claimed in claim 15, wherein:
after a time corresponding to the scheduling time offset value T_{OFFSET}, the user equipment switches to a second bandwidth part different from the first bandwidth part to communicate with the first TRP and the second TRP.

18-28. (canceled)

29. A user equipment capable of simultaneously connecting to a mobile communication system comprising a plurality of transmission/reception points (TRPs) for mobile network communication, comprising:
wherein the user equipment receives a first switching request from a first TRP and receives a second switching request from a second TRP while using a first bandwidth part in a first time slot, wherein the first switching request comprises a first scheduling time offset, and the second switching request comprises a second scheduling time offset;
wherein the user equipment calculates a scheduling time offset value T_{OFFSET} according to corresponding scheduling time offsets decoded from the switching requests; the user equipment does not transmit and receive wireless signals within a duration of time after receiving the first switching request and the second switching request; wherein:
the first switching request and the second switching request are used to request a bandwidth part in use for switching; and
the duration of time is determined by the scheduling time offset value T_{OFFSET}.

30. The user equipment as claimed in claim 29, wherein:
the first switching request and the second switching request are uplink scheduling downlink control information (DCI) carried by a physical downlink control channel and occupying first three symbol times in the first time slot;
the duration of time is counted from an end of a third symbol time in the first time slot and extends to a beginning of a time slot corresponding to the scheduling time offset value T_{OFFSET}; and
the scheduling time offsets are uplink transmission offsets K₂ as defined by a 5G new radio technology standard specification release 16.

31. The user equipment as claimed in claim 29, wherein:
after a time corresponding to the scheduling time offset value T_{OFFSET}, the user equipment switches to a second bandwidth part different from the first bandwidth part to communicate with the first TRP and the second TRP.

32-42. (canceled)
